(19) United States
(12) Patent Application Publication
(10) Pub. No.: US 2025/0061254 A1
(43) Pub. Date: Feb. 20, 2025

(54) MODEL GENERATION METHOD, RECORDING MEDIUM, AND INFORMATION PROCESSING APPARATUS

(71) Applicant: Tokyo Electron Limited, Tokyo (JP)

(72) Inventors: Takahiro NAKAMURA, Sapporo City (JP); Yusuke OGAWA, Sapporo City (JP); Takahiko KATO, Miyagi (JP); Hironori MOKI, Miyagi (JP)

(73) Assignee: Tokyo Electron Limited, Tokyo (JP)

(21) Appl. No.: 18/938,566

(22) Filed: Nov. 6, 2024

Related U.S. Application Data
(63) Continuation of application No. PCT/JP2023/016791, filed on Apr. 28, 2023.

(30) Foreign Application Priority Data
May 6, 2022 (JP) 2022-076699

(51) Int. Cl. G06F 30/27; G06F 30/3308; G06F 30/337; G06F 119/18

(52) U.S. Cl. CPC G06F 30/27; G06F 30/3308; G06F 30/337; G06F 2119/18

(57) ABSTRACT

To provide a model generation method, a recording medium, and an information processing apparatus. The method includes, via a computer: acquiring a plurality of variable groups for constructing a process recipe, state data indicating a state of a processing object before executing a specific step of the process recipe, and target data indicating a target state of the processing object; evaluating the state of the processing object obtained by selecting one variable group from the plurality of variable groups and executing one step characterized by the selected one variable group; and generating a model for constructing the process recipe by reinforcement learning using the acquired state data and target data and a reward determined according to the evaluated state of the processing object.

### CROSS-REFERENCE TO RELATED APPLICATIONS

This application is a bypass continuation application of international application No. PCT/JP2023/016791 having an international filing date of Apr. 28, 2023, and designating the United States, the international application being based upon and claiming the benefit of priority from Japanese Patent Application No. 2022-076699 filed on May 6, 2022, the entire contents of each are incorporated herein by reference.

### TECHNICAL FIELD

The present invention relates to a model generation method, a recording medium, and an information processing apparatus.

### BACKGROUND

In a conventional semiconductor processing apparatus, control values for various control components forming a semiconductor processing apparatus are described for each step to generate a process recipe, and various processes are performed according to each step of the generated process recipe.

Patent Literature 1 discloses a method for generating a prediction model showing a relationship between an input parameter value and an output value that is an actual measurement value in a processing result in order to search for an input parameter value set in the semiconductor processing apparatus for processing into a target processing shape.

### CITATION LIST

### Patent Documents

Patent Literature 1: JP2019-165123A

### SUMMARY

An object of the present disclosure is to provide a model generation method, a recording medium, and an information processing apparatus, which can present a variable group recommended for a process recipe according to a current shape of a processing object.

A model generation method of the present disclosure includes, via a computer: acquiring a plurality of variable groups for constructing a process recipe, state data indicating a state of a processing object before executing a specific step of the process recipe, and target data indicating a target state of the processing object; evaluating the state of the processing object obtained by selecting one variable group from the plurality of variable groups and executing one step characterized by the selected one variable group; and generating a model for constructing the process recipe by reinforcement learning using the acquired state data and target data and a reward determined according to the evaluated state of the processing object.

According to the present disclosure, it is possible to present a variable group recommended for the process recipe according to the current shape of the processing object.

### BRIEF DESCRIPTION OF DRAWINGS

FIG. 1 is an explanatory diagram for explaining an outline of an information processing system according to an embodiment.

FIG. 2 is an explanatory diagram for explaining a configuration of data obtained in a manufacturing process.

FIG. 3 is an explanatory diagram for explaining a configuration of a proxel.

FIG. 4 is a block diagram illustrating an internal configuration of an information processing apparatus.

FIG. 5 is a conceptual diagram illustrating an example of a proxel database.

FIG. 6 is a schematic diagram of a reinforcement learning algorithm.

FIG. 7 is a schematic diagram illustrating a configuration example of a learning model.

FIG. 8 is a flowchart for explaining a generation procedure of the learning model.

FIG. 9 is a flowchart for explaining a recipe construction procedure using the learning model.

FIG. 10 is a schematic diagram illustrating a configuration example of a learning model according to Embodiment 2.

FIG. 11 is a flowchart for explaining a fine tuning process procedure.

FIG. 12 is a flowchart for explaining a process recipe evaluation procedure.

### DETAILED DESCRIPTION

Hereinafter, an embodiment will be described with reference to the drawings.

### Embodiment 1

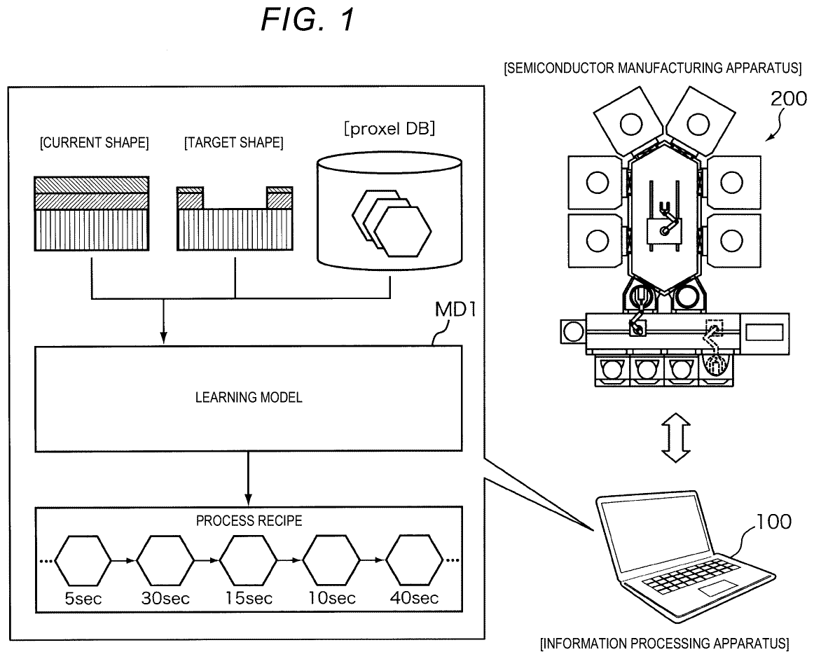

FIG. 1 is an explanatory diagram for explaining an outline of an information processing system according to an embodiment. The information processing system according to the embodiment includes an information processing apparatus 100 and a semiconductor manufacturing apparatus 200. The information processing apparatus 100 and the semiconductor manufacturing apparatus 200 are communicably connected to each other, for example. The semiconductor manufacturing apparatus 200 may include any apparatus for performing a semiconductor manufacturing process, such as an exposure apparatus, an etching apparatus, a film forming apparatus, an ion implantation apparatus, an ashing apparatus, or a sputtering apparatus. The information processing apparatus 100 constructs a recommended process recipe with respect to a manufacturing process executed in the semiconductor manufacturing apparatus 200, and presents the constructed process recipe to a manufacturer or the like (user).

The process recipe used in the manufacturing process is configured by a plurality of steps. The step herein refers to the smallest processing unit in which a state (an attribute of a processing target or a state of the semiconductor manufacturing apparatus) is changed in the semiconductor manufacturing process. Therefore, when the state changes the passage of time, in the present embodiment, before the passage of time and after the passage of time are regarded as separate steps.

The information processing apparatus 100 constructs a process recipe recommended to a user by selecting one variable group used in each step from a plurality of variable groups prepared in advance, and determining processing contents to be executed in each step.

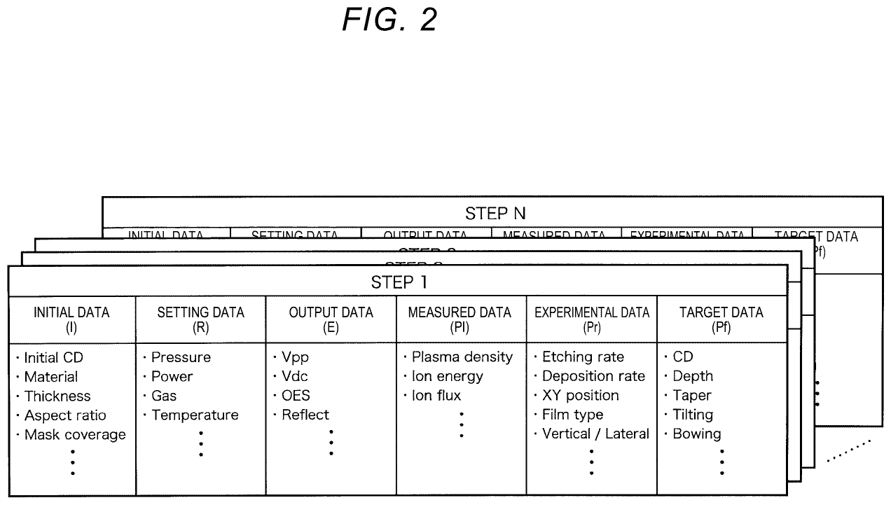

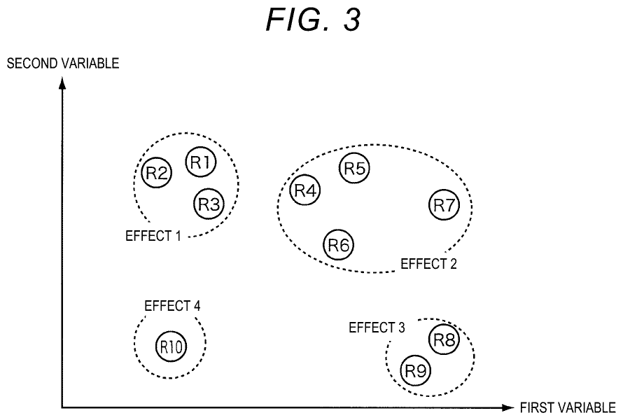

In the present embodiment, a series of variables (such as setting values and control values) that produce the same effect in each step will be referred to as a variable group. In the following description, the variable group will also be referred to as a proxel. The proxel is the smallest unit of data for determining the processing contents in each step, and is a term similar to the smallest unit of an image (picture element) being called a pixel and the smallest unit of a three-dimensional structure (volume element) being called voxel. In the example of FIG. 1, one proxel is indicated by one regular hexagon. The details of the proxel will be specifically described with reference to FIGS. 2 to 3.

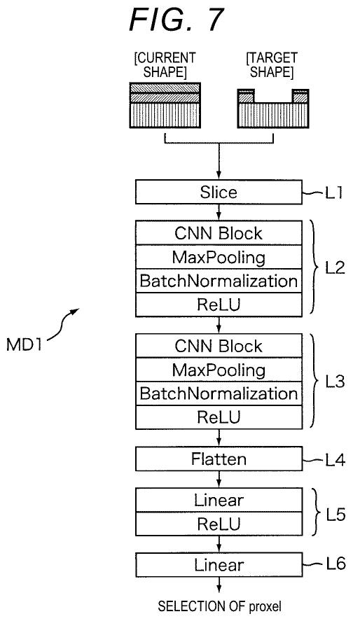

In the present embodiment, a learning model MD1 (see FIG. 7) based on reinforcement learning is used to search for a proxel for constructing the process recipe. For example, when state data indicating a current state of a processing target (processing object) and target data indicating a target state of the processing target set by the user are input, the learning model MD1 is trained such that information about the proxel recommended in the next step is output. The information processing apparatus 100 constructs a process recipe recommended to the user by executing an arithmetic operation using the learning model MD1 in each step, and determining a proxel to be selected in each step based on the arithmetic operation result. A configuration of the learning model MD1 and a method of generating the learning model MD1 will be described in detail later.

FIG. 2 is an explanatory diagram for explaining a configuration of data obtained in a manufacturing process. The semiconductor manufacturing process is performed step by step in accordance with a plurality of steps constituting the process recipe. In each of the plurality of steps, for example, data of six items that include initial data (I), setting data (R), output data (E), measured data (PI), experimental data (Pr), and target data (Pf) are obtained.

The initial data (I) is data relating to a processing target. The initial data (I) is set by the user, for example. The initial data (I) includes data such as an initial critical dimension (Initial CD), a material (Material), a thickness (Thickness), an aspect ratio (Aspect ratio), and a mask coverage (Mask coverage).

The setting data (R) is data set for the semiconductor manufacturing apparatus. The setting data (R) is set by the user according to attributes of the processing target or a final target, characteristics of the semiconductor manufacturing apparatus to be used, and the like. The setting data (R) includes, for example, data such as a pressure inside a chamber (Pressure), power of a radio-frequency power supply (Power), a gas flow rate (Gas), a temperature inside the chamber or a surface temperature of the processing target (Temperature).

The output data (E) is data output from the semiconductor manufacturing apparatus. The output data (E) includes, for example, data such as a peak-to-peak voltage (Vpp) of an RF signal, a direct-current self-bias voltage (Vdc), an emission intensity by emission spectroscopy (OES), and a reflected wave power (Reflect).

The measured data (Pl) is data relating to an environment in which the manufacturing process is performed. The measured data (Pl) is measured using various sensors and measurement apparatuses. The measured data (Pl) includes, for example, data such as plasma density (Plasma density), ion energy (Ion energy), and ion flow rate (Ion flux).

The experimental data (Pr) is data relating to a result obtained in each step. The experimental data (Pr) is measured using various sensors and measurement apparatuses. The experimental data (Pr) includes, for example, data such as an etching rate (Etching rate), a film formation rate (Deposition rate), an XY coordinate (XY position), a type of a thin film (Film type), and vertical/horizontal classification (Vertical/Lateral).

The target data (Pf) is data relating to the final target. The target data (Pf) is set by the user according to an attribute to be reached by the final target. The target data (Pf) includes data such as a critical dimension (CD), a depth (Depth), a taper angle (Taper), a tilting angle (Tilting), and bowing (Bowing).

The items illustrated in FIG. 2 are examples, and the types of items included in each step are not limited to those illustrated. For example, there may be items that are not included according to the manufacturing process or step, or different items may be included according to the manufacturing process or step. In addition, the data of each item illustrated in FIG. 2 is an example, and the type of data included in each item is not limited to the illustrated data. The data of each item may be appropriately set according to the manufacturing process or step.

In the present embodiment, a series of variables (variable groups) for which similar effects can be obtained in the same manufacturing process and the same step is defined as a proxel. In this case, the effect in a predetermined step of the manufacturing process is an amount derived as a difference between a state of the processing object before executing the step and a state of the processing object after executing the step.

FIG. 3 is an explanatory diagram for explaining a configuration of a proxel. For the sake of simplification, the configuration of the proxel will be described by taking as an example a two-dimensional feature space in which a horizontal axis represents a first variable and a vertical axis represents a second variable. By executing the same manufacturing process plural times while variously changing the first variable and the second variable in the process recipe, and analyzing the execution results, it is possible to find ranges of the first variable and the second variable for which similar effects can be obtained in each step.

Regions indicated by symbols R1 to R10 in FIG. 3, respectively, are regions defined by determining the ranges of the first variable and the second variable. When the same step in the same manufacturing process is executed using the variables in the respective regions R1, R2, and R3 among the regions R1 to R10, the same effect as “Effect 1” is obtained. In this case, sets of the plurality of variables included in the regions R1, R2, and R3 are grouped as one variable group, and the variable group is defined as one proxel (referred to as a proxel 1).

Similarly, when the same step in the same manufacturing process is executed using the variables in the respective regions R4, R5, R6, and R7, the same effect as “Effect 2” different from “Effect 1” is obtained. In this case, sets of the plurality of variables included in the regions R4, R5, R6, and R7 are grouped as one variable group, and the variable group is defined as another proxel (referred to as a proxel 2) different from the preceding proxel 1.

Similarly, when the same step in the same manufacturing process is executed using the variables in the respective regions R8 and R9, the same effect as “Effect 3” different from “Effect 1” and “Effect 2” is obtained. In this case, the sets of the plurality of variables included in the regions R8 and R9 are grouped as one variable group, and the variable group is defined as another proxel (referred to as a proxel 3) different from the preceding proxel 1 and proxel 2.

Furthermore, when the same step in the same manufacturing process is executed using the variables in the region R10, a single effect called “Effect 4” different from “Effect 1” to “Effect 3” is obtained. In this case, sets of the plurality of variables included in the region R10 are grouped as one variable group, and the variable group is defined as another proxel (referred to as a proxel 4) different from the preceding proxel 1 to proxel 3.

In FIG. 3, the configuration of the proxel has been described using the two-dimensional feature space for simplification, but when each step includes K variables (K is an integer of 1 or more), a K-dimensional feature space can be used to find a range (spatial region) of each variable for which the same effect is obtained, and proxel can be defined by grouping the variables for each effect.

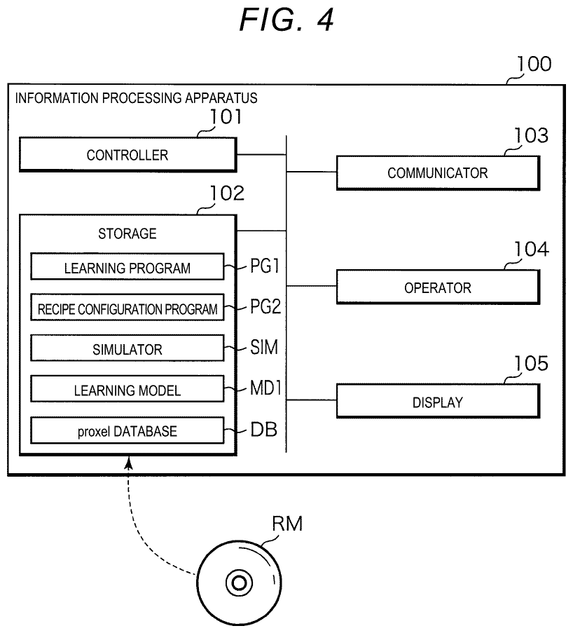

Hereinafter, the configuration of the information processing apparatus 100 that performs recipe construction using the proxel will be described. FIG. 4 is a block diagram illustrating an internal configuration of the information processing apparatus 100. The information processing apparatus 100 is, for example, a dedicated or general-purpose computer including a controller 101, a storage 102, a communicator 103, an operator 104, and a display 105.

The controller 101 includes a central processing unit (CPU), a read only memory (ROM), a random access memory (RAM), and the like. The ROM provided in the controller 101 stores control programs and the like for controlling the operation of each component of the hardware provided in the information processing apparatus 100. The CPU in the controller 101 reads and executes control programs stored in the ROM and various types of computer programs stored in the storage 102, and controls the operation of each component of the hardware, and thus causes the entire apparatus to function as the information processing apparatus of the present disclosure. The RAM provided in the controller 101 temporarily stores data used during the execution of an arithmetic operation.

In the embodiment, although the controller 101 includes the CPU, the ROM, and the RAM, the configuration of the controller 101 is not limited to the above-described configuration. The controller 101 may be, for example, one or a plurality of control circuits or arithmetic circuits that include a graphics processing unit (GPU), a field programmable gate array (FPGA), a digital signal processor (DSP), a quantum processor, a volatile or nonvolatile memory, or the like. In addition, the controller 101 may include functions such as a clock for outputting date and time information, a timer for measuring the time elapsed from the time when a measurement start instruction is applied to the time when a measurement end instruction is applied, and a counter for counting the number.

The storage 102 includes storage devices such as a hard disk drive (HDD), a solid state drive (SSD), and an electronically erasable programmable read only memory (EEPROM). The storage 102 stores various types of computer programs executed by the controller 101 and various data used by the controller 101.

The computer programs (program products) stored in the storage 102 include a learning program PG1 for generating the learning model MD1, a recipe construction program PG2 for constructing a recipe, and a simulator SIM that virtually performs a manufacturing process in accordance with the process recipe. The computer programs may be single computer programs or may be configured to include a plurality of computer programs. In addition, these computer programs may partially use an existing library.

The computer programs such as the learning program PG1 and the recipe construction program PG2 stored in the storage 102 are provided by a non-temporary recording medium RM on which the computer programs are recorded in a readable manner. The recording medium RM is a portable memory such as a CD-ROM, a USB memory, a secure digital (SD) card, a micro SD card, or a compact flash (registered trademark). The controller 101 reads various types of computer programs from the recording medium RM using a reading device (not illustrated) and stores the read various types of computer programs in the storage 102. In addition, the computer program stored in the storage 102 may be provided through communication. In this case, the controller 101 may acquire the computer program through communication via the communicator 103, and may store the acquired computer program in the storage 102.

Further, the storage 102 stores the learning model MD1. The learning model MD1 is a learning model generated by reinforcement learning to be described later. The storage 102 stores configuration information about layers constituting the learning model MD1, information about nodes constituting each layer, and model parameters such as weights and biases between the nodes.

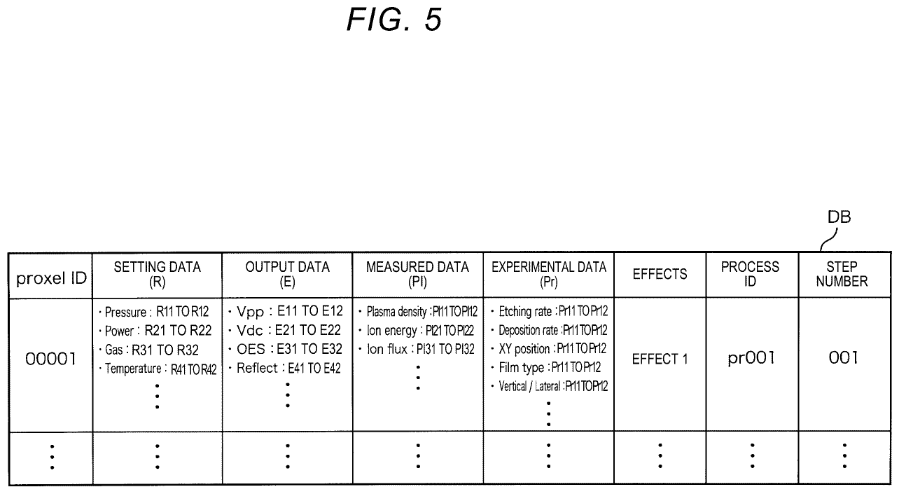

Further, the storage 102 includes a proxel database DB. FIG. 5 is a conceptual diagram illustrating an example of the proxel database DB. The proxel database DB stores an individual proxel determined as described above in association with a proxel ID, a data range of each data, an effect, a process ID, and a step number. That is, many process conditions summarized for each manufacturing process, each step, and each effect are stored in the proxel database DB. In the proxel database DB, when an ID of one proxel is designated, one process condition (variable group) of the semiconductor for which the same effect is obtained is determined.

In the present embodiment, the proxel database DB is provided inside the information processing apparatus 100, but the proxel database DB may be provided outside the information processing apparatus 100 and accessed via the communicator 103 to acquire necessary data.

The communicator 103 includes a communication interface for transmitting and receiving various types of data to and from an external apparatus. As the communication interface of the communicator 103, a communication interface conforming to a communication standard such as a local area network (LAN) can be used. The external apparatus may include the semiconductor manufacturing apparatus 200 and a server apparatus (not illustrated). When data to be transmitted is input from the controller 101, the communicator 103 transmits the data to the external apparatus that is a destination, and outputs the received data to the controller 101 when the data transmitted from the external apparatus is received.

The operator 104 includes operating devices such as a touch panel, a keyboard, and switches, and receives various types of operations and settings by the user or the like. The controller 101 performs appropriate controls based on various operation information supplied by the operator 104, and causes the storage 102 to store setting information as necessary.

The display 105 includes a display device such as a liquid crystal monitor or an organic electro-luminescence (EL), and displays information to be notified to the user or the like in response to an instruction from the controller 101.

In the present embodiment, the information processing apparatus 100 may be a single computer or may be a computer system including a plurality of computers, peripheral devices, or the like. In addition, the information processing apparatus 100 may be a virtual machine in which entities are virtualized, or may be a cloud. Furthermore, in the present embodiment, the information processing apparatus 100 and the semiconductor manufacturing apparatus 200 have been described as being separate from each other. However, the information processing apparatus 100 may be provided inside the semiconductor manufacturing apparatus 200.

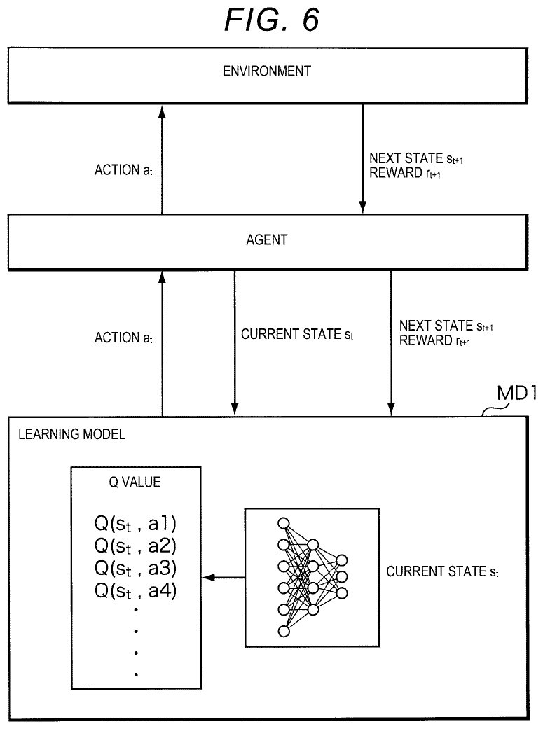

In the present embodiment, a reinforcement learning algorithm is used to construct the process recipe that is presented to the user. FIG. 6 is a schematic diagram of the reinforcement learning algorithm. The reinforcement learning algorithm is an algorithm that deals with a problem in which an agent placed in a certain environment observes a current state of an observation target and determines an action to be taken. Hereinafter, a deep Q-network (DQN), which is one method of reinforcement learning, will be described.

A learning model used in the reinforcement learning is trained to output values (Q values) of action value functions for each of possible actions a1, a2, . . . , and an (n is an integer of 2 or more) when a current state sₜ of the observation target is input. The DQN is a method for approximating the action value function by a neural network and performing reinforcement learning.

In the present embodiment, the learning model MD1 is expressed using the neural network that approximates an action value function, and performs reinforcement learning to output information about a value when each proxel is selected, according to the current state of the processing object. The state sₜ input into the learning model MD1 is, for example, differential data between the state data indicating the current state of the processing object and the target data indicating the target state of the processing object. More specifically, differential data between image data indicating a current shape of the processing object and image data indicating a target shape of the processing object can be used.

The learning model MD1 outputs values Q (sₜ, a1), Q (sₜ, a2), . . . , Q (sₜ, an) of the action value functions for each of the possible actions a1, a2, . . . , and an (n is an integer of 2 or more) to an input of the current state sₜ. The value of the action value function represents an expected value of profits obtained in the future when the action a is selected in the state sₜ, which is also referred to as the Q value. That is, the value (Q value) of the action value function does not represent a short-term reward, but represents a value in the long-term sense. In the present embodiment, the action a corresponds to executing one step of configuring the process according to a condition defined by the selected proxel.

The agent refers to a Q value output from the learning models MD1 for each action, and selects the action aₜ having the highest Q value among the possible actions a1, a2, . . . , and an that may be taken in the state sₜ. The environment is updated by the selected action aₜ to determine the next state sₜ₊₁. In the present embodiment, the agent is the controller 101 of the information processing apparatus 100, and the environment is a simulator that virtually executes the manufacturing process in accordance with the process recipe.

The agent obtains a reward rₜ₊₁ from the environment in accordance with the next state sₜ₊₁ generated by the selection of the action aₜ. When the manufacturing process to be performed is an etching process, the reward rₜ₊₁ is determined based on, for example, a scraped amount of the processing object, a loss of scrape residues, the loss of excessive scrapings, a validity of the selected proxel, and the like.

The agent learns actions of maximizing rewards (profits) obtained in the future through trial and error. Specifically, the agent successively updates the learning model MD1 based on the following Equation (1), using the state sₜ, the state sₜ₊₁, and the reward rₜ₊₁ for the previous action aₜ.

$$Q ( {s}_{t} , {a}_{t} ) ← Q ( {s}_{t} , {a}_{t} ) + α \{ {r}_{t + 1} + γ \cdot max Q ( {s}_{t + 1} , {a}_{t + 1} ) - Q ( {s}_{t} , {a}_{t} ) \} \qquad ( 1 )$$

In this case, a is a learning coefficient, γ is a discount rate, and rₜ₊₁ is a reward obtained as a result of the action aₜ. The learning coefficient α is a parameter for determining a speed of learning, and satisfies a relationship of 0<α<1. The discount rate γ is a parameter for indicating a degree to which a future state is to be discounted in evaluation, and satisfies the relationship of 0<γ<1.

In the Q learning, the model parameters of the learning model MD1 are trained using an error back propagation method or the like such that the second term on the right side of Equation (1) becomes zero. This means that when the state sₜ shifts to the state sₜ₊₁ by the action aₜ, the Q value of the action aₜ approaches a value when the Q value is the highest in the next state sₜ₊₁.

The agent repeats the update of the learning model MD1 until a predetermined end condition is satisfied. By repeating the update, the learning model MD1 is trained such that the reward rₜ₊₁ is maximized. The end condition is appropriately set, for example, when a predetermined number of updates have been performed, when the shape of the processing object approaches the target shape or when the processing object is no longer scraped.

The configuration of the learning model MD1 generated by the reinforcement learning described above will be described. FIG. 7 is a schematic diagram illustrating a configuration example of the learning model MD1. The learning model MD1 includes, for example, six layers from a first layer L1 to a sixth layer L6 illustrated in FIG. 7. The first layer L1 includes a slice layer. Differential data between the image data indicating the current shape of the processing object and the image data indicating the target shape is input into the first layer L1. The first layer L1 cuts a part of the input differential data and outputs the cut differential data to a second layer at a subsequent stage.

The second layer L2 includes a convolutional neural network (CNN) block, a maxpooling layer, a batchnormalization layer, and a rectified linear unit (ReLu) layer. The second layer L2 extracts features from the differential data input from the first layer L1, and outputs the extracted data to a third layer at a subsequent stage.

Similar to the second layer L2, the third layer L3 includes the CNN block, the maxpooling layer, the batchnormalization layer, and the ReLU layer. The second layer L2 extracts features from the data input from the second layer L2, and outputs the extracted data to the third layer at a subsequent stage.

The fourth layer L4 includes a flatten layer, the fifth layer L5 includes a linear layer and a ReLU layer, and the sixth layer includes a linear layer. The final linear layer provided in the sixth layer L6 includes the same number of nodes as the number of possible actions a1, a2, . . . , and an, and outputs a value of the action value function for each of the corresponding actions a1, a2, . . . , and an from each node.

In the present embodiment, since the difference between the image data indicating the current shape of the processing object and the image data indicating the target shape is input into the learning model MD1, there is the advantage that it is easy to select an appropriate proxel when the image data approaches the target shape.

Hereinafter, the operation of the information processing apparatus 100 will be described.

The information processing apparatus 100 executes a generation process of the learning model MD1 in a learning phase before the actual operation is started, and executes a recipe construction process using the learning model MD1 in an operational phase after the learning model MD1 is generated.

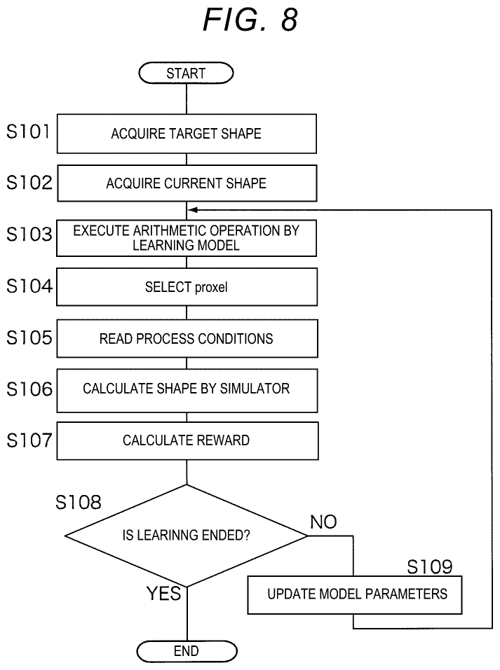

FIG. 8 is a flowchart for explaining a generation procedure of the learning model MD1. The controller 101 of the information processing apparatus 100 executes a learning program PG1 stored in the storage 102 and executes the following procedure to generate the learning model MD1 in the learning phase. It is assumed that initial values are given to the model parameters describing the learning model MD1 before the start of the learning.

The controller 101 acquires image data indicating a target shape of the processing object (step S101). The target shape is a target cross-sectional shape for the processing object, which is set by the user. For example, the controller 101 can acquire from a user terminal (not illustrated) through the communicator 103.

The controller 101 acquires image data indicating a current shape of the processing object (step S102). In this case, the image data indicating the current shape of the processing object is, for example, image data of a cross-sectional shape of the processing object obtained through calculation using the simulator SIM.

The controller 101 inputs differential data between the image data indicating the current shape of the processing object and the image data indicating the target shape into the learning model MD1, and executes an arithmetic operation using the learning model MD1 (step S103). The arithmetic operation performed by the learning model MD1 obtains a value (Q value) of the action value function for each of the possible actions.

The controller 101 selects a proxel based on the arithmetic operation result of the learning model MD1 (step S104). The controller 101 selects an action a such that the Q value is the highest among Q values of the respective actions calculated according to the current state sₜ, thereby selecting the proxel. The controller 101 causes the storage 102 to store information about the selected proxel.

The controller 101 refers to the proxel database DB to read process conditions stored in association with the selected proxel (step S105). As the process conditions, the controller 101 may read data ranges of setting data, output data, measured data, and experimental data.

The controller 101 executes a simulation using the simulator SIM based on the process conditions read from the proxel database DB, and calculates the shape of the processing object (step S106).

The controller 101 calculates a reward based on the calculated shape of the processing object (step S107). For example, the controller 101 compares the current shape of the processing object acquired in step S102 with the shape of the processing object calculated by the simulator SIM in step S106, thereby calculating a scraped amount, and gives a reward of, for example, −0.1 to 0.1, according to the scraped amount. Further, the controller 101 may compare the target shape acquired in step S101 with the shape of the processing object calculated in step S106 to calculate a loss of scrape residues or a loss of excessive scrapings, and may give a reward of, for example, −0.1 to 0.1 with respect to the loss of scrape residues, and may give a reward of, for example, −0.1 to 0 to the loss of excessive scrapings. Furthermore, when the proxel input in step S103 is invalid, the controller 101 gives a reward of −1.

The controller 101 determines whether to end the learning (step S108). For example, the controller 101 determines that the learning has been ended when the number of steps of the manufacturing process is equal to or greater than a threshold value, when the loss of excessive scrapings is equal to or greater than the threshold value, when the difference between the current shape and the target shape is less than the threshold value, or when the invalid proxel is selected the set number of times or greater.

When it is determined that the learning has not been ended (NO in step S108), the controller 101 updates the model parameters including weights or biases between the nodes configuring the learning model MD1 (step S109), and the process returns to step S103. After returning the process to step S103, the controller 101 regards the shape calculated by the simulator SIM as the current shape, and executes the arithmetic operation using the learning model MD1. In the Q learning, the model parameters of the learning model MD1 are trained such that the second term in Equation (1) described above approaches zero by repeating the arithmetic operations in steps S103 to S109 described above.

When it is determined that the learning has been ended (S108: YES), the controller 101 ends the process according to the flowchart. In this case, the storage 102 stores the model parameters of the learning model MD1 that has been trained.

The controller 101 may generate the learning model MD1 by executing the procedure illustrated in the flowchart of FIG. 8 plural times for the same process. In this case, the controller 101 may advance the reinforcement learning by giving a reward after each process has been ended. For example, the controller 101 may give a reward of −1 to 1 or a reward of 0 to 1 according to the number of steps with respect to the loss of final scrape residues. Further, the controller 101 may give a reward of −1 to 0 for the loss of excessive scrapings.

The present embodiment has been described by way of example with respect to a learning algorithm based on the Q learning. However, the method of generating the learning model MD1 is not limited to the Q learning, and any reinforcement learning algorithm such as temporal difference (TD) learning, policy gradients, state-action-reward-state-action (SARSA), Actor-critic, or the like can be used.

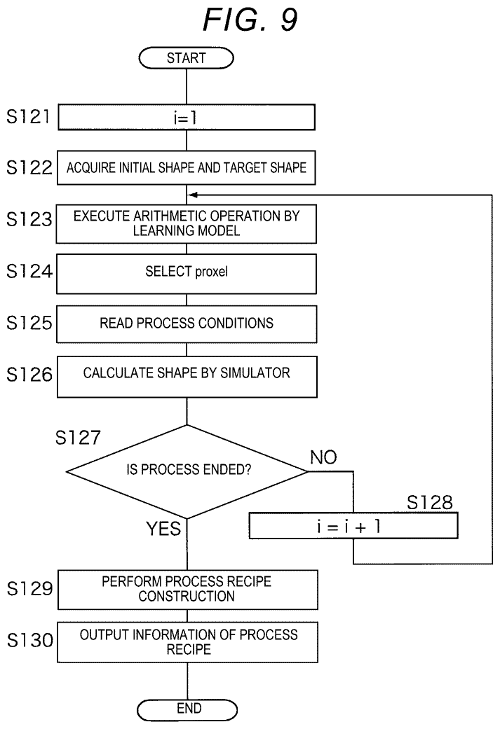

FIG. 9 is a flowchart illustrating a recipe construction procedure using the learning model MD1. The controller 101 of the information processing apparatus 100 executes a recipe construction program PG2 stored in the storage 102 and executes the following procedure to construct the process recipe, in the operational phase after the learning model MD1 is generated. Before the start of the operation, it is assumed that the storage 102 stores the trained model parameters.

The controller 101 initializes an index of the proxel used for the process recipe to i=1 (step S121).

The controller 101 acquires image data indicating an initial shape and target shape of the processing object (step S122). The initial shape is a cross-sectional shape of the processing object before the start of the process set by the user, and the target shape is a target cross-sectional shape of the processing object, which is set by the user. For example, the controller 101 can acquire from a user terminal (not illustrated) through the communicator 103.

The controller 101 inputs differential data between the image data indicating the current shape of the processing object and the image data indicating the target shape into the learning model MD1, and executes an arithmetic operation using the learning model MD1 (step S123). The arithmetic operation result obtained by the learning model MD1 includes information about the recommended proxel. In the present embodiment, the information about the action with the highest Q value among the Q values calculated for each of the possible actions corresponds to the information about the recommended proxel.

The controller 101 selects a proxel based on the arithmetic operation result of the learning model MD1 (step S124). The controller 101 causes the storage 102 to store the selected proxel as a proxel of an index i.

The controller 101 refers to the proxel database DB to read the process conditions stored in association with the selected proxel (step S125) and execute simulation of the simulator SIM, thereby calculating the shape of the processing object (step S126).

The controller 101 determines whether to end the process (step S127). For example, when the difference between the shape (current shape) of the processing object calculated in step S126 and the target shape is less than the threshold value, the controller 101 determines that the process has been ended.

When it is determined that the process has not been ended (NO in step S127), the controller 101 increases the index i of the proxel by +1 (step S128), and the process returns to step S123. The controller 101 regards the shape calculated in step S126 as the current shape, and repeats the arithmetic operation using the learning model MD1.

On the other hand, when it is determined that the process has been ended (step S127: YES), the controller 101 constructs a process recipe by combining proxels of indices i=1 to n (step S129), and outputs information about the constructed process recipe (step S130). In this case, n is an index of the proxel at the end of the process. The controller 101 may transmit the information about the constructed process recipe from the communicator 103 to the user terminal or may cause the display 105 to display the process recipe information.

As described above, in Embodiment 1, the learning model MD1 for constructing a recipe can be generated by using the reinforcement learning. Since the trained learning model MD1 can be stored in the storage 102, an arithmetic operation can be performed by reading the model parameters of the learning model MD1 from the storage 102 during operation, so that a process recipe recommended to the user can be constructed.

In the present embodiment, since the difference between the image data indicating the current shape and the image data indicating the target shape is adopted as an input into the learning model MD1, it becomes easy to select an appropriate proxel when the current shape approaches the target shape, so that a more appropriate process recipe can be constructed.

In the present embodiment, the differential data between the initial shape and the target shape is input into the trained learning model MD1, so that a process recipe of the entire manufacturing process is constructed. Alternatively, the controller 101 may input differential data between shape data at a first timing of the manufacturing process and shape data at a second timing later than the first timing into the learning model MD1, so that a partial process recipe from the first timing to the second timing may be generated.

Further, the controller 101 may display the value of the action value function calculated for the proxel together with the information about the proxel selected in each step. In the present embodiment, since the proxel is selected based on the value of the action value function, the value of the action value function is presented to the user together, thereby presenting reliability of the proxel selection result to the user together.

Furthermore, the controller 101 may use a gradient-weighted class activation mapping (Grade-CAM) technique to display a location of interest in the proxel selection by a heat map. For example, the controller 101 may retrieve the results of the second layer L2, the third layer L3, and the fourth layer L4 constituting the learning model MD1, propagate back in error using the classification results by the fourth layer L4, and generate a heat map that indicates the location of interest by calculating the gradients of convolution layers in the third layer L3 and the second layer L2.

### Embodiment 2

In Embodiment 2, a modification example of the learning model will be described.

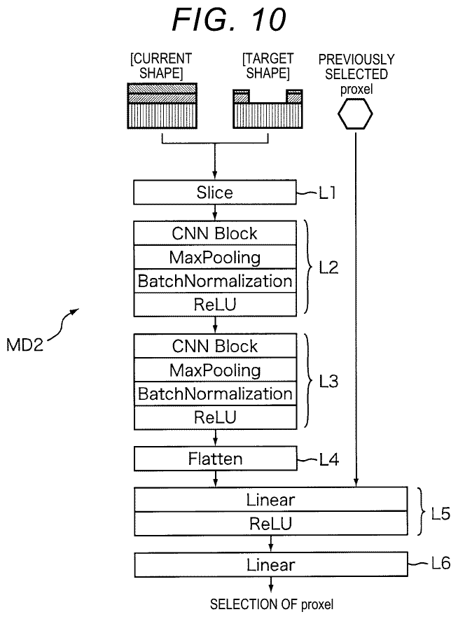

FIG. 10 is a schematic diagram illustrating a configuration example of a learning model MD2 according to Embodiment 2. The configuration of the learning model MD2 in Embodiment 2 is the same as that of the learning model MD1 in Embodiment 1, and the learning model MD2 includes a first layer L1 to a sixth layer L6.

In Embodiment 2, information about the previously selected proxel is input into the learning model MD2 in addition to the differential data between the image data indicating the current shape of the processing object and the image data indicating the target shape. That is, in Embodiment 2, differential data between image data indicating the shape of the processing object before an i-th step (i is an integer of 2 or more) is executed in the process recipe and image data indicating the target shape and information about a proxel selected when an i-1st step is executed are input into the learning model MD2. Specifically, a tensor after the flattening in the fourth layer L4 may be combined in a one-hot representation with the index of the previously selected proxel. That is, a vector in which an element corresponding to the selected proxel is 1 and the remaining elements are 0 may be combined.

In Embodiment 2, the reinforcement learning is performed in consideration of the information about the previously selected proxel. For example, when the same proxel as the previous proxel is selected, the reward is set to zero, and when a proxel different from the previous proxel is selected, the reinforcement learning may be performed by setting the reward to a negative value (for example, −0.5). Since the reinforcement learning process procedure and the recipe construction procedure after the training are the same as those in Embodiment 1, a detailed description thereof will be omitted.

In Embodiment 2, since the reinforcement learning is performed in consideration of the information about the previously selected proxel, for example, it is expected to construct a more natural process recipe with less proxel switching.

### Embodiment 3

In Embodiment 3, fine tuning of the learning model will be described.

The information processing apparatus 100 according to Embodiment 3 performs fine tuning of the learning model MD1 when the initial shape of the processing object changes, when the data of the proxel stored in the proxel database DB changes, or the like. Hereinafter, a case where the initial shape of the processing object changes and the fine tuning of the learning model MD1 is performed will be described.

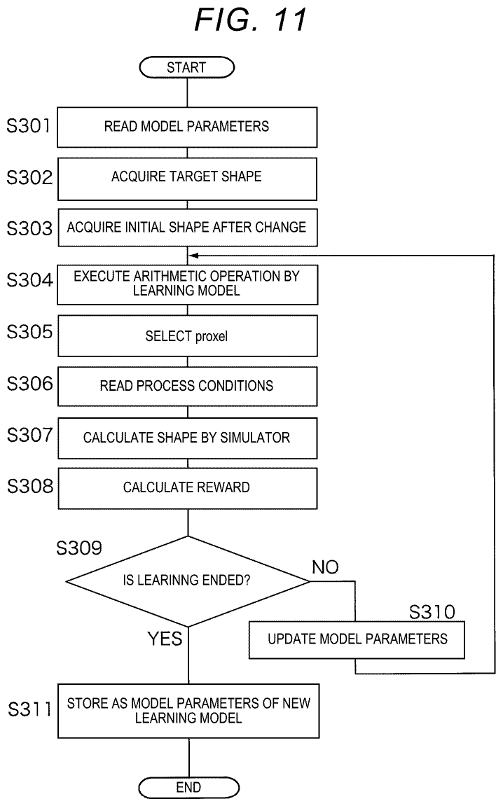

FIG. 11 is a flowchart illustrating a fine tuning process procedure. When a new learning model is generated by performing fine tuning on the trained learning model MD1, the controller 101 reads the model parameters of the learning model MD1 from the storage 102 (step S301).

The controller 101 acquires the image data indicating the target shape of the processing object (step S302), and acquires the image data indicating the initial shape of the processing object after the change (step S303).

The controller 101 inputs differential data between the image data indicating the current shape of the processing object and the image data indicating the target shape into the learning model MD1, and performs an arithmetic operation using the learning model MD1 (step S304). That is, an arithmetic operation may be performed based on the model parameters read in step S301. The arithmetic operation performed by the learning model MD1 obtains a value (Q value) of the action value function for each of the possible actions.

Based on the arithmetic operation result obtained by the learning model MD1, the controller 101 selects a proxel (step S305), and reads process conditions stored in association with the selected proxel (step S306).

The controller 101 executes a simulation using the simulator SIM based on the process conditions read from the proxel database DB to calculate the shape of the processing object (step S307), and calculates a reward based on the calculated shape of the processing object (step S308).

It determine whether the learning has been ended (step S309), and when it is determined that the learning has not been ended (S309: NO), the controller 101 updates the model parameters including weights or biases between the nodes constituting the learning model MD1 (step S310), and the process returns to step S304.

When it is determined that the learning has been ended (step S309: YES), the controller 101 causes the storage 102 to store the finally obtained model parameters as model parameters of the new learning model (step S311).

As described above, in Embodiment 3, since it is possible to use the trained learning model MD1 to generate a new learning model by fine tuning, it is possible to shorten a time required for training even when the learning model for the new processing object is generated.

In the flowchart of FIG. 11, the fine tuning for the different initial shapes has been described. However, even when the data of the proxel stored in the proxel database DB changes, a new learning model can be generated without taking time by the fine tuning.

### Embodiment 4

In Embodiment 4, a configuration for evaluating a recipe set by the user using the learning model MD1 will be described.

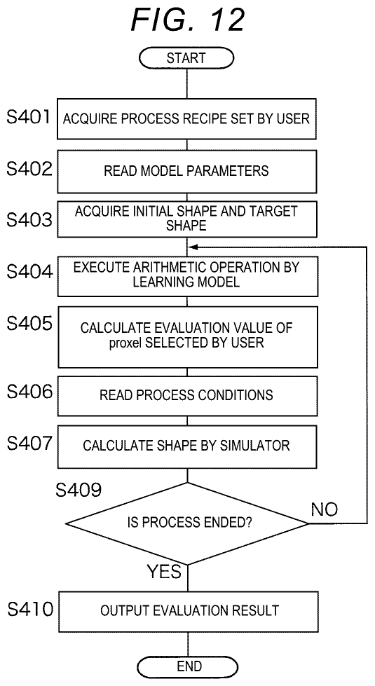

FIG. 12 is a flowchart illustrating a process recipe evaluation procedure. The controller 101 acquires a process recipe set by the user (step S401). For example, the controller 101 can acquire the process recipe from the user terminal (not illustrated) through the communicator 103.

The controller 101 reads the model parameters of the learning model MD1 from the storage 102 (step S402). In this case, it is assumed that the model parameters of the learning model MD1, which is generated for the same or similar processing object as or to the processing object assumed in the process recipe set by the user is read.

The controller 101 acquires the initial shape and the target shape (step S403), and inputs the differential data into the learning model MD1 to execute an arithmetic operation using the learning model MD1 (step S404).

The controller 101 calculates an evaluation value of the proxel selected in the process recipe set by the user (step S405). For example, the controller 101 calculates probability that the proxel selected by the user is selected by the learning model MD1 as the evaluation value, based on the arithmetic operation result in step S404.

Based on the information about the proxel selected by the user, the controller 101 reads the process conditions from the proxel database DB (step S406), and calculates the shape by the simulator (step S407).

It is determined whether the process has been ended (step S409), and when it is determined that the process has not been ended (step S409: NO), the process returns to step S404, and the controller 101 executes the evaluation of the proxel selected by the user in the next step.

When it is determined that the process has been ended (step S409: YES), the controller 101 outputs an evaluation result of the process recipe that includes the evaluation values of the respective proxel (step S410). The controller 101 may transmit the evaluation result of the calculated process recipe from the communicator 103 to the user terminal or may cause the display 105 to display the evaluation result.

As described above, in Embodiment 4, the process recipe set by the user can be quantitatively evaluated by using the trained learning model MD1.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the present disclosure is not limited thereto. The claims may also be described using a format of multi-claims reciting at least one multi-claim (multi-multi claims).

The embodiments disclosed herein are exemplary in all respects and are required to be considered to be not restrictive embodiments. The scope of the present invention is indicated by the claims, not the meaning described above, and is intended to include meanings equivalent to the claims and all changes within the scope.

1. A model generation method comprising, via a computer:
acquiring a plurality of variable groups for constructing a process recipe, state data indicating a state of a processing object before executing a specific step of the process recipe, and target data indicating a target state of the processing object;
evaluating the state of the processing object obtained by selecting one variable group from the plurality of variable groups and executing one step characterized by the selected one variable group; and
generating a model for constructing the process recipe by reinforcement learning using the acquired state data and target data and a reward determined according to the evaluated state of the processing object.

2. The model generation method according to claim 1,
wherein the model is configured to output information about a variable group recommended in each step of the process recipe when data, which is based on the state data indicating the state of the processing object and the target data indicating the target state of the processing object, is input.

3. The model generation method according to claim 2,
wherein the state data is image data indicating a shape of the processing object before the specific step is executed,
the target data is image data indicating a target shape of the processing object, and
the computer executes a process of inputting, into the model, differential data between the image data indicating the shape of the processing object and the image data indicating the target shape.

4. The model generation method according to claim 1,
wherein the computer executes a process of executing the one step by a simulator.

5. The model generation method according to claim 1,
wherein the computer executes a process of evaluating the state of the processing object obtained by executing the one step by calculating a change in the state of the processing object before and after executing the one step, and a difference between the state and the target state of the processing object after executing the one step.

6. The model generation method according to claim 5,
wherein the computer executes a process of determining the reward according to the calculated change in the state and the calculated difference between the state and the target state.

7. The model generation method according to claim 1,
wherein the model is configured to, when data based on state data indicating a state of the processing object before an i-th (i is an integer of 2 or more) step is executed in a process recipe to be constructed and the target data indicating the target state of the processing object, and information about a variable group selected when an i-1st step is executed are input, output information about the variable group recommended in the i-th step.

8. The model generation method of claim 7,
wherein the computer executes a process of determining the reward according to whether the variable group selected when executing the i-1st step is the same as a variable group selected when executing the i-th step.

9. The model generation method according to claim 1,
wherein the computer executes a process of executing the process plural times to determine the reward according to a state of the processing object that is finally obtained in each process and the number of steps in each process.

10. A non-transitory computer readable recording medium storing a computer program for causing a computer to execute processes of:
acquiring a plurality of variable groups for constructing a process recipe, state data indicating a state of a processing object before executing a specific step of the process recipe, and target data indicating a target state of the processing object;
evaluating the state of the processing object obtained by selecting one variable group from the plurality of variable groups and executing one step characterized by the selected one variable group; and
generating a model for constructing the process recipe by reinforcement learning using the acquired state data and target data and a reward determined according to the evaluated state of the processing object.

11. The recording medium according to claim 10,
wherein the computer program causes the computer to execute a process of generating a new model for another processing object different from the processing object by using a model parameter of the generated model as an initial value.

12. A non-transitory computer readable recording medium storing a computer program for causing a computer to execute processes of:
acquiring state data indicating a state of a processing object before executing a specific step of the process recipe and target data indicating a target state of the processing object;
inputting the acquired state data and target data into the model generated by the model generation method according to claim 1 execute an arithmetic operation via the model;
specifying a variable group to be adopted in the step based on an arithmetic operation result of the model; and
constructing the process recipe based on the variable group specified in each of the plurality of steps.

13. The recording medium according to claim 12,
wherein the model is configured to output a value of an action value function for each of the plurality of variable groups, and
the computer program causes the computer to execute a process of outputting a value of an action value function of a variable group selected in each step.

14. The recording medium according to claim 12,
wherein the computer program causes the computer to execute a process of visualizing a portion of the state data contributing to selection of the variable group.

15. The recording medium according to claim 12,
wherein the computer program causes the computer to execute a process of comparing a process recipe set by a user with a process recipe constructed by the model.

16. An information processing apparatus comprising:
a storage configured to store a plurality of variable groups for constructing a process recipe;
an acquirer configured to acquire state data indicating a state of a processing object before executing a specific step of the process recipe and target data indicating a target state of the processing object;
an evaluator configured to evaluate the state of the processing object obtained by selecting one or more variable groups from the plurality of variable groups and executing one or more steps characterized by the selected one or more variable groups; and
a generator configured to generate a model for constructing the process recipe by reinforcement learning using the acquired state data and target data and a reward calculated according to the evaluated state of the processing object.

17. An information processing apparatus comprising:
an acquirer configured to acquire state data indicating a state of a processing object before executing a specific step of the process recipe and target data indicating a target state of the processing object;
an arithmetic operator configured to input the acquired state data and target data into the model generated by the model generation method according to claim 1 execute an arithmetic operation via the model;
a specifier configured to specify a variable group to be adopted in the step based on an arithmetic operation result of the model; and
a constructor configured to construct the process recipe based on the variable group specified in each of the plurality of steps.
